(19) United States
(12) Patent Application Publication
(10) Pub. No.: US 2026/0003637 A1
(43) Pub. Date: Jan. 1, 2026

(54) GENERATING COMPUTING ENVIRONMENT CONFIGURATIONS FOR HIGH PERFORMANCE COMPUTING SYSTEMS AND APPLICATIONS

(71) Applicant: NVIDIA Corporation, Santa Clara, CA (US)

(72) Inventor: Adam Brady Simpson, San Jose, CA (US)

(21) Appl. No.: 18/757,162

(22) Filed: Jun. 27, 2024

(51) Int. Cl. G06F 9/4401

(52) U.S. Cl. CPC G06F 9/4401

(57) ABSTRACT

Disclosed are systems and techniques for generating computing environment configuration files. The techniques include receiving, from a device of a user, an indication of one or more applications executable in a computing environment. At least one application of the one or more applications can have associated dependency information. The techniques include generating, based on the one or more applications and associated dependency information, a set of dependency constraints; determining a solution to the set of dependency constraints; and determining a collection of applications based on the solution to the set of dependency constraints. The techniques include generating, based on the collection of applications, a representation of operations to be performed to prepare the one or more applications for execution in the computing environment.

### TECHNICAL FIELD

At least one embodiment pertains to generation of configuration files for computing environments.

### BACKGROUND

High performance computing applications can require a high degree of customization. For example, application configurations can require different settings based on the architecture of the execution environment. Additionally, the computing applications can have dependencies that require their own configuration customizations. Thus, it can be difficult to apply all of the customizations necessary to execute high performance computing applications on a given target architecture.

### BRIEF DESCRIPTION OF THE DRAWINGS

FIG. 1 is a block diagram of an example computer system for generating computing environment configuration files, according to at least one embodiment;

FIG. 2 is a data flow diagram of generating a computing environment configuration file, according to at least one embodiment;

FIG. 3 is a flow diagram of an example method for generating computing environment configuration files; according to at least one embodiment;

FIG. 4A illustrates inference and/or training logic, according to at least one embodiment of the present disclosure;

FIG. 4B illustrates inference and/or training logic, according to at least one embodiment;

FIG. 5 illustrates training and deployment of a neural network, according to at least one embodiment;

FIG. 6 is an example data flow diagram for an advanced computing pipeline, according to at least one embodiment;

FIG. 7 is a system diagram for an example system for training, adapting, instantiating and deploying machine learning models in an advanced computing pipeline, according to at least one embodiment.

### DETAILED DESCRIPTION

The present disclosure provides for systems and techniques that allow for generation of computing environment configurations. The computing environment configuration can include one or more applications to execute and one or more dependency applications to include in the environment. The computing environment configuration can also include ordered operations that need to be performed to prepare the computing environment to execute the one or more applications.

The applications can be containerized. Containers can package application source code, dependencies, and runtime environment into reusable units, which can be deployed anywhere a container runtime is available. One existing platform for building and running containerized applications is a Docker platform that can provide a Docker installation to launch containers at a specific computing environment. In order to launch a container, a container image (e.g., to define the initial state of a container filesystem) can be created using a Dockerfile that includes a list of instructions to be processed by the Docker platform to assemble the container image.

Some compute tasks require specialized applications, and the applications can require customizations specific to the computing environment that is executing the application. For example, high performance computing (HPC) applications often require customization based on the computing environment that is executing the applications and based on needs of the user executing the applications. Dockerfiles are often used for portability of applications across computing environments and computing hardware, but using the same Dockerfile across different computing environments for HPC applications can reduce the environment-specific customizations available for the applications.

Aspects of the present disclosure address the above and other deficiencies by providing a tool that is capable of providing both a high degree of customization required for high performance computing applications and the benefits of containerization. For example, in some embodiments, a Dockerfile can be generated to enable high performance computing using specific computing resources (e.g., a specific graphical processing unit (GPU)). In one or more embodiments, the generated Dockerfiles include instructions necessary to generate a containerized execution environment image. The instructions can download and configure applications that will be executed within a containerized execution environment. Executing a container image generated based on a Dockerfile will execute the one or more applications configured within the image.

Some embodiments of the present disclosure can include a fact generator, a dependency solver, a topological sorter, and a solution generator. Some embodiments also include a Dockerfile generator. A user can specify one or more applications that are to be executable within the target computing environment. The user can also specify what computing resources are available within the target computing environment. The fact generator can generate a set of dependency constraints (e.g., Boolean satisfiability formulas) based on the target computing resources and applications (or representations thereof) received from the user. For example, the fact generator may generate one or more “facts” (e.g., Boolean satisfiability variables and/or formulas) for each application specified by the user. In some embodiments, the facts generated for an application may be based on the target computing resources. In some embodiments, facts may be generated based on required dependencies of an application, which may, in turn, be based on the target computing resources.

After facts have been generated for the specified applications and their dependencies, the dependency solver can be used to solve the dependency equation (e.g., satisfy the Boolean satisfiability formulas). In some embodiments, more than one solution may exist, and the dependency solver may be configured to select a solution based on one or more heuristics (e.g., newer versions of an application that satisfies the formulas may be preferred over older versions, applications that have already been compiled (e.g., in a previous step) may be preferred over applications that will need to be compiled, etc.). The dependency solver may output a new set of applications, with their corresponding configurations and dependencies, based on a solution of the dependency equation(s)/constraints.

The topological sorter may generate one or more directed graphs (e.g., directed acyclic graphs (DAGs)) based on the new set of applications from the dependency solver. In some embodiments, a first graph may be generated that includes applications necessary for compiling other applications (e.g., a graph for a build environment), and a second graph may be generated that includes applications necessary to run the user-specified applications (e.g., a graph for a runtime environment). By splitting the applications into different graphs, the storage requirements of the resulting container image can be reduced.

Edges between applications in the graph can represent dependencies. Edges can have a designation corresponding to an application stage (e.g., build, install, run, etc.). Applications in the graph may be sorted and/or grouped by stage.

The solution generator can receive the sorted DAGs from the topological sorter and can output representations of the operations performed at each application stage for each application of the DAG (e.g., operations for building the application, operations for installing the application, operations for running the application, etc.).

The Dockerfile generator can convert the generated representations from the solution generator into a set of instructions that are included in the Dockerfile. The resulting Dockerfile may be able to build an optimized containerized execution environment image based on the target computing resources and applications specified by the user. Execution of the containerized execution environment image may allow the user to execute the one or more specified applications (e.g., high performance computing applications) using the specified computing resources. The computing environment may be optimized for the computing resources of the environment.

The advantages of the disclosed techniques include but are not limited to enabling the customizations necessary to execute high performance computing applications on a given target architecture. For example, such customizations can be enabled via a reproducible generation of Dockerfiles that can create containerized execution environment images with reduced storage requirements. The Dockerfile can include a combination of built-from-source applications and prepackaged applications (e.g., applications packaged for Debian™ systems, applications packaged for Python™, etc.).

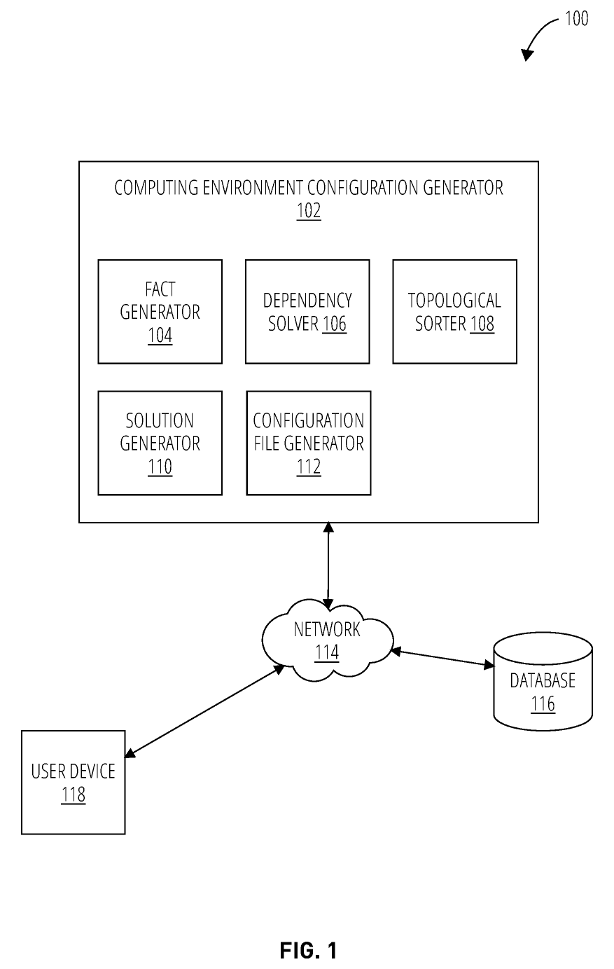

FIG. 1 is a block diagram of an example computer system 100 for generating computing environment configuration files, according to at least one embodiment. System 100 can include computing environment configuration generator 102, user device 118, and database 116 connected via network 114. Network 114 can be a public network (e.g., the Internet), a private network (e.g., a local area network (LAN), or wide area network (WAN)), a wireless network, a personal area network (PAN), another network type, and/or a combination thereof.

Computing environment configuration generator 102 can generate a computing environment configuration file based on configurations received from a user (e.g., user device 118). Computing environment configuration generator 102 can include one or more applications running on a desktop computer, a laptop computer, a smartphone, a tablet computer, a server, a wearable device, a virtual reality (VR)/augmented reality (AR)/mixed reality (MR) headset or heads up display, a digital avatar or chat bot kiosk, an in-vehicle infotainment computing device, and/or any suitable computing device capable of performing the techniques described herein. Computing environment configuration generator 102 can include fact generator 104, dependency solver 106, topological sorter 108, solution generator 110, and configuration file generator 112.

Fact generator 104 can receive a configuration from a user and generate a dependency constraint (e.g., formulate a dependency expression) or set of constraints. The configuration from the user can include one or more applications (or application identifiers) that the user wants to be executable in a computing environment. Each application can have associated dependency information. For example, a first application can require a second application in order to install correctly, such as a compiler, (e.g., a build dependency) and/or can require a second application in order to run correctly (e.g., a runtime dependency). The second application can be included in the final computing environment configuration file so the first application works properly. Each application can have one or more dependencies.

The configuration from the user can also include information about the computing environment that will execute the one or more specified applications, such as available hardware resources (e.g., central processing units (CPUs), graphics processing units (GPUs), etc.), CPU architecture, amount of available memory, and/or the like. In some embodiments, the computing environment configuration file for executing the one or more specified applications on a first set of hardware can be different than a computing environment configuration file for executing the same one or more applications on a second set of hardware. For example, an application can be configured to execute efficiently on the first set of hardware and may not be able to execute as efficiently on the second set of hardware.

Fact generator 104 can generate a set of dependency constraints that represents the relationships between the applications specified by the user and their corresponding dependencies. In some embodiments, the set of dependency constraints is a Boolean satisfiability problem, where each application (e.g., specified by a user or included as a dependency) corresponds to one or more Boolean variables. For example, a particular application can have a Boolean variable indicating that the application is a build dependency and/or a Boolean variable indicating that the application is a runtime dependency. In some embodiments, the set of dependency constraints can include one or more Boolean variables generated for one or more applications not specified by the user. For example, in some embodiments, a set of default applications can be included in the generated computing environment regardless of whether the user included those application in their request. In some embodiments, the set of dependency constraints is an answer set programming problem or a constraint satisfaction problem.

Dependency solver 106 can solve the set of dependency constraints generated by fact generator 104. For example, dependency solver 106 can find a solution to the system of equations (e.g., Boolean satisfiability problem) generated by fact generator 104. In some embodiments, dependency solver 106 uses one or more heuristics while finding a solution to the set of dependency constraints. For example, different versions of a given application may satisfy the same Boolean variable(s) of the set of dependency constraints and dependency solver 106 can use a heuristic to prefer newer versions of the application over older versions of the application. In some embodiments, an artificial intelligence (AI) model (e.g., machine learning model, deep learning model, graph neural network, etc.) can be used to solve the set of dependency constraints generated by fact generator 104.

Based on the determined solution to the set of dependency constraints, dependency solver 106 can identify one or more application packages (e.g., stored in database 116) needed to generate the computing environment configuration file. In some embodiments, an application package can have additional metadata, such as application features that should be enabled, compiler flags that need to be used when compiling the application, and the like. Dependency solver 106 can determine which metadata is included with each application package based on the determined solution to the set of dependency constraints.

Topological sorter 108 can sort the application packages determined by dependency solver 106 to ensure that each application's dependencies are available before the application needs them in the generated computing environment configuration file. Fact generator 104 and dependency solver 106 can ensure that the application's dependencies are included somewhere in the generated computing environment configuration file, and topological sorter 108 can ensure that the dependencies are available (e.g., installed, included) before the application needs them (e.g., before the application is run, executed, etc.).

In some embodiments, topological sorter 108 can generate multiple sorted sets of application packages, each for a different target environment. For example, topological sorter 108 can generate one sorted set of application packages for a build environment and one set of sorted application packages for a runtime environment. The build environment can be used to prepare all of the applications for execution. The runtime environment can include all applications that are required to execute the applications the user specified for inclusion in the computing environment configuration file. In some embodiments, the build environment can include applications that are not included in the runtime environment.

In some embodiments, the sets of application packages generated by topological sorter 108 can be represented as two graphs. In some embodiments, the graphs are directed acyclic graphs. Each node of the graph can represent an application package, and each (directed) edge of the graph can represent a dependency. In some embodiments, each edge of the graph can have an associated phase, such as “build,” “install,” and/or “run.” The phase of the edge/dependency can indicate where the application package needs to be included in the generated computing environment configuration file. For example, “build” dependencies can be included in the computing environment configuration file before “install” dependencies, which in turn can come before the “run” dependencies.

During sorting, topological sorter 108 can assign each application package to a particular level (e.g., by performing a “leveled” topological sort). Application packages at the same level can be processed (e.g., built, installed, run, etc.) without consideration to other application packages at the same level. For example, if package A and package B are on a first level and package C is on the next level, package A and B can be processed before package C. In some embodiments, it is irrelevant whether package A is processed before, after, or concurrent with package B, so long as both are processed before package C.

In some embodiments, all edges with a “run” phase are grouped together in the same “level,” and “build” and “install” edges are treated as in a traditional topological sort. In some embodiments, topological sorter 108 can determine a condensation on the dependency graph (e.g., a directed acyclic graph formed by contracting the strongly connected components of the dependency graph), check for disallowed cycles, topologically sort the strongly connected components from the condensation, and then walk all of the nodes taking the edge “phase” into account to determine if the node (e.g., application package) can be placed in the current sort level, or if it must be added to a new level in the sort.

Solution generator 110 can generate an abstract representation of the computing environment configuration file based on the one or more sorted sets of application packages from topological sorter 108 and the metadata corresponding to each application package from dependency solver 106. Each application package can include one or more ordered operation representations (e.g., operation abstractions) that can be used to install and/or run the application. For example, the ordered operation representations can include actions that need to be performed to build the application (e.g., “download the source code from X,” “set environment variable Y to Z,” “execute build command C with flags D, E, and F,” etc.), actions that need to be performed to install the application (e.g., “copy file G from H to I and file J from K to L,” etc.), and/or actions that need to be performed to run the application (e.g., “set environment variable V to W,” “execution binary located at M with parameters N and O,” etc.). Thus, solution generator 110 can create an output (e.g., a “solution”, an abstract configuration file) that contains an ordered list of operation representations for preparing a computing environment to execute the applications specified by the user.

Configuration file generator 112 can generate a computing environment configuration file based on the ordered list of operations representations included in the solution from solution generator 110. In some embodiments, the computing environment is a containerized computing environment (e.g., Docker™ container, Open Container Initiative (OCI) container, etc.) and the generated computing environment configuration file is a container file (e.g., Dockerfile). In some embodiments, the computing environment is a virtual machine or bare metal server and the generated computing environment configuration file is a shell script. Configuration file generator 112 can translate the ordered list of operations representations into discrete operations that can be performed by the process that executes the generated computing environment configuration file (e.g., Docker™ engine, terminal emulator, etc.).

For example, configuration file generator 112 can convert the solution from solution generator 110 into a Dockerfile that can be provided to the user. The Dockerfile can be used to build a Docker™ image, which can create a containerized execution environment for running the applications originally requested by the user.

User device 118 can include a desktop computer, a laptop computer, a smartphone, a tablet computer, a server, a wearable device, a virtual reality (VR)/augmented reality (AR)/mixed reality (MR) headset or heads up display, a digital avatar or chat bot kiosk (e.g., a talking kiosk), an in-vehicle infotainment computing device, and/or any suitable computing device capable of performing the techniques described herein and/or capable of interacting with a system performing the techniques described herein. User device 118 can interact with computing environment configuration generator 102 (e.g., via network 114) and may provide a computing environment request to computing environment configuration generator 102. For example, computing environment request can include one or more applications (or application identifiers) that the user wants to be executable in a computing environment. The computing environment request can also include information about the computing environment that will execute the one or more specified applications, such as available hardware resources (e.g., CPUs, GPUs, etc.), CPU architecture, amount of available memory, and/or the like. User device 118 can receive, from computing environment configuration generator 102, a configuration file based on the computing environment request. The configuration file can include instructions that can be executed by a process to initialize a computing environment that includes the one or more applications that the user identified in the computing environment request.

In some embodiments, the generated configuration file can include one or more sections directed to different application phases. For example, the generated configuration file can have a first section for a “build” application phase and a second section for a “run” application phase. In some embodiments, the different sections of the generated configuration file correspond to the different graphs generated by topological sorter 108. In some embodiments, the “run” section of the generated configuration file can use one or more assets generated by the “build” section of the generated configuration file. In some embodiments, an application is included in a first section of the generated configuration file and is not included in a second section of the generated configuration file. For example, a compiler can be included in a “build” section of the generated configuration file and can be excluded from a “run” section of the generated configuration file, resulting in smaller storage space requirements for the computing environment corresponding to the “run” section of the generated configuration file.

Database 116 can include a persistent storage capable of storing configuration environment requests, application packages, application metadata, application dependency information, dependency constraints, dependency solutions, generated solutions (e.g., abstract configuration file), sorted dependency graphs, generated computing environment configuration files, and/or the like. In some embodiments, database 116 can include one or more AI models for solving dependency constraints and/or corresponding model weights. Database 116 can be hosted by one or more storage devices, such as main memory, magnetic or optical storage disks, tapes, or hard drives, network-attached storage (NAS), storage area network (SAN), and so forth. Although depicted as separate from computing environment configuration generator 102, in at least some embodiments, database 116 can be a part of computing environment configuration generator 102. In at least some embodiments, database 116 can include a network-attached file server, while in other embodiments, database 116 can include some other type of persistent storage such as an object-oriented database, a relational database, a vector database, an in-memory database, and so forth, that may be hosted by a server machine or one or more different machines coupled to computing environment configuration generator 102 via network 114.

Application packages stored in database 116 can include the information required to include the application in the generated computing environment configuration file. The information can include dependency information related to the application, source code information (e.g., where the source code is available, instructions for building the application from the source code, etc.), optional features and/or configurations that can be enabled in the application (e.g., compiler flags, etc.), and/or the like. In some embodiments, an application package is a wrapper around another package. For example, an application package stored in database 116 can be a wrapper around a Debian™ package, a Python™ package, or another bundled binary package (e.g., a package from a package manager for an operating system, etc.). In such a case, the application package can include information about the application being wrapped (e.g., name of the package, package repository information, version information, etc.).

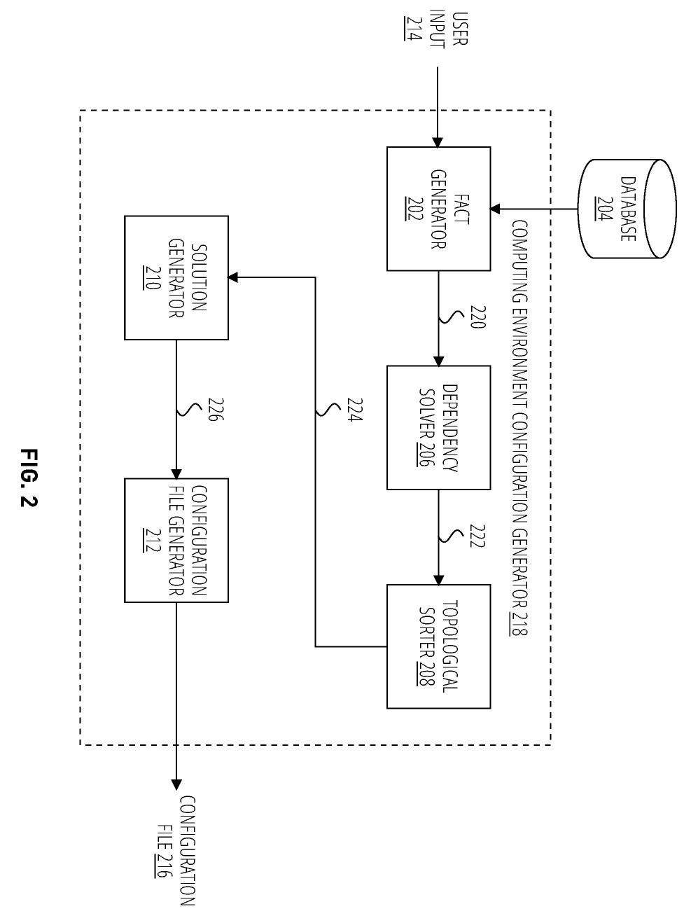

FIG. 2 is a data flow diagram of generating a computing environment configuration file 216, according to at least one embodiment. Computing environment configuration generator 218 can be used to generate configuration file 216 based on a user input 214. User input 214 can include applications (or identifiers thereof) the user wants executable in the computing environment generated based on configuration file 216, features of one or more of the applications that should be enabled, and/or the target hardware that will be executing the computing environment generated based on the configuration file 216.

Fact generator 202 can receive user input 214 and generate a set of dependency constraints based on the received input. In some embodiments, fact generator 202 can load information about the applications identified in user input 214 from database 204, such as dependency information, available features, compiler flags, and/or the like. Fact generator 202 can generate set of dependency constraints 220 that represents the relationships between the applications identified in user input 214 and their corresponding dependencies. In some embodiments, the set of dependency constraints is a Boolean satisfiability problem, where each application (e.g., specified by a user or included as a dependency) corresponds to one or more Boolean variables.

Dependency solver 206 can receive set of dependency constraints 220, find a solution to the problem, and generate dependency solution 222. In some embodiments, set of dependency constraints 220 can be solved using one or more heuristics and a satisfiability algorithm. In some embodiments, set of dependency constraints 220 can be solved using one or more AI models. For example, set of dependency constraints 220 can include expressions of dependency relationships between applications using natural language and an AI model trained for natural language process (NLP) can determine which applications need to be included in the computing environment configuration file to satisfy all of the application dependencies.

In some embodiments, dependency solver 206 can find a solution to the Boolean satisfiability problem represented by set of dependency constraints 220 comprising a plurality of Boolean variables with corresponding true/false values. Application packages corresponding to the Boolean variables with “true” values can be determined and can be included in dependency solution 222. In some embodiments, dependency solution 222 can also include metadata related to one or more applications. The metadata can include information such as application features that should be enabled, compiler flags that need to be used when compiling the application, and the like.

Topological sorter 208 can sort the application packages included in dependency solution 222 to ensure that each application's dependencies are available before the application needs them in the generated computing environment configuration file. In some embodiments, topological sorter 208 can generate two sorted sets of application packages: one for a build environment and one for a runtime environment. The build environment can be used to prepare one or more (e.g., all) of the applications for execution. The runtime environment can include all applications that are required to execute the applications the user specified for inclusion in the computing environment configuration file.

In some embodiments, the sets of application packages generated by topological sorter 208 can be represented as two directed acyclic graphs (DAGs). Each node of the graph can represent an application package, and each (directed) edge can represent a dependency. Topological sorter 208 can sort the application packages into different “levels” based on a phase (e.g., “build,” “install,” “run”) associated with each dependency. Topological sorter 208 can generate one or more dependency graphs 224 and provide them to solution generator 210.

Solution generator 210 can generate an abstract representation of the computing environment configuration file based on the one or more dependency graphs 224 from topological sorter 208 and the metadata corresponding to each application package from dependency solver 206. Each application package can include one or more ordered operation representations (e.g., operation abstractions or abstract operations) that can be used to build, install, and/or run the application. Solution generator 210 can combine the abstract operations of each application package included in solution 226 into an ordered list based on the sorted order of dependency graphs 224. The abstract operations can represent operations that can be performed within a computing environment to execute the corresponding application.

Configuration file generator 212 can generate a computing environment configuration file (e.g., configuration file 216) based on the ordered list of abstract operations included in solution 226. Configuration file generator 212 can translate the ordered list of abstract operations into discrete operations that can be performed in a particular computing environment. For example, configuration file generator 212 can convert the ordered list of abstract operations in solution 226 into discrete operations for a containerized computing environment, a virtual machine computing environment, and/or a bare metal server.

Configuration file 216 can be provided to user in response to receiving user input 214. The user can use configuration file 216 to initialize a computing environment that includes the applications identified in user input 214.

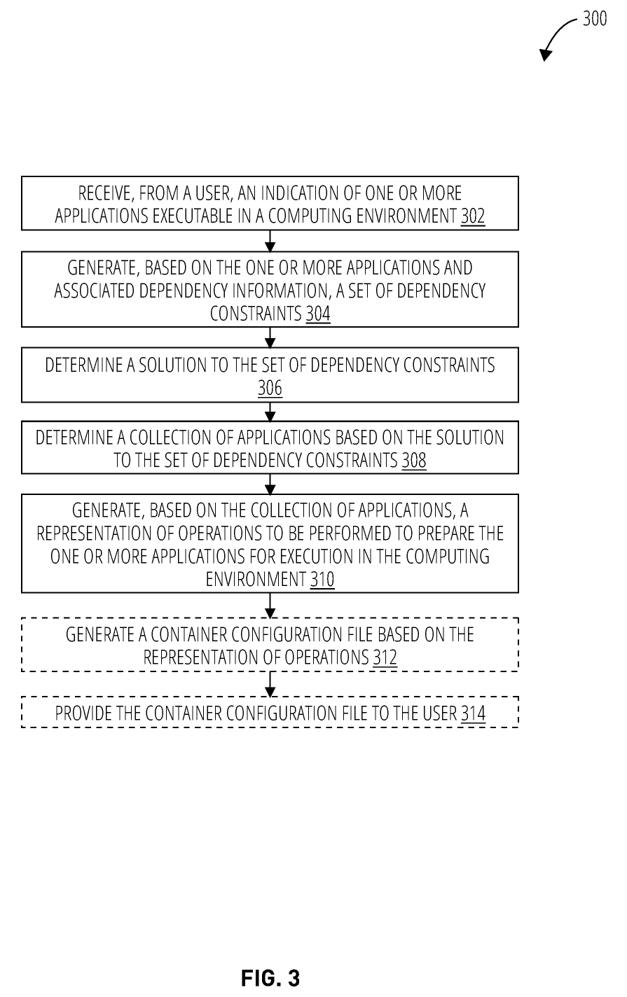

FIG. 3 is a flow diagram of an example method 300 for generating computing environment configuration files, according to at least one embodiment.

Method 300 can be performed using one or more processing units (e.g., CPUs, GPUs, accelerators, physics processing units (PPUs), data processing units (DPUs), etc.), which may include (or communicate with) one or more memory devices. In at least one embodiment, method 300 can be performed using a processing device or processing devices. In at least one embodiment, method 300 can be performed using processing units of computing environment configuration generator 102 of FIG. 1. In at least one embodiment, processing units performing method 300 can be executing instructions stored on a non-transient computer readable storage media. In at least one embodiment, method 300 can be performed using multiple processing threads (e.g., CPU threads and/or GPU threads), individual threads executing one or more individual functions, routines, subroutines, or operations of the method. In at least one embodiment, processing threads implementing method 300 can be synchronized (e.g., using semaphores, critical sections, and/or other thread synchronization mechanisms). Alternatively, processing threads implementing method 300 can be executed asynchronously with respect to each other. Various operations of method 300 can be performed in a different order compared with the order shown in FIG. 3. Some operations of method 300 can be performed concurrently with other operations. In at least one embodiment, one or more operations shown in FIG. 3 may not always be performed.

FIG. 3 is a flow diagram of an example method 300 for generating computing environment configuration files, according to at least one embodiment. At block 302, processing units executing method 300 can receive, from a device of a user, an indication of one or more applications executable in a computing environment. At least one application of the one or more applications can have associated dependency information. At block 304, processing units can generate, based on the one or more applications and associated dependency information, a set of dependency constraints. In some embodiments, the set of dependency constraints is a Boolean satisfiability formula. At block 306, processing units can determine a solution to the set of dependency constraints. In some embodiments, determining the solution to the set of dependency constraints can include at least one of determining if the set of dependency constraints is satisfiable or applying a machine learning model to the set of dependency constraints. At block 308, processing units can determine a collection of applications based on the solution to the set of dependency constraints. At block 310, processing units can generate, based on the collection of applications, a representation of operations to be performed to prepare the one or more applications for execution in the computing environment.

In some embodiments, at block 312, processing units can further generate a container configuration file based on the representation of operations. At block 314, processing units can further provide the container configuration file to the user.

In some embodiments, processing units can further sort the collection of applications to determine an order of operations. In some embodiments, generating the representation of operations can be further based on the order of operations. In some embodiments, the computing environment is a containerized computing environment. In some embodiments, a first application of the one or more applications can be at least one of a Debian™ package, a Python™ package, or a built-from-source package.

### INFERENCE AND TRAINING LOGIC

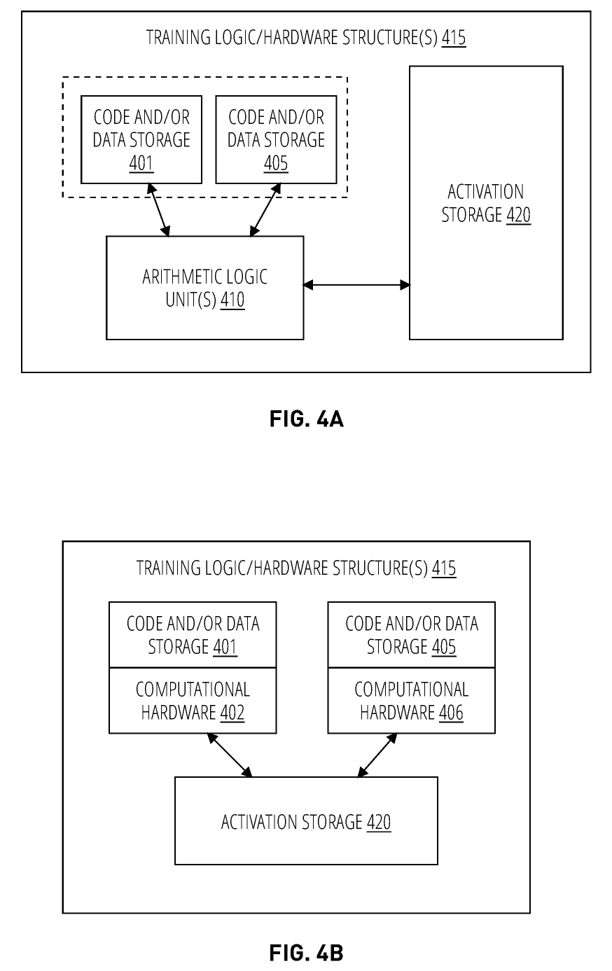

FIG. 4A illustrates inference and/or training logic 415 used to perform inferencing and/or training operations associated with one or more embodiments.

In at least one embodiment, inference and/or training logic 415 may include, without limitation, code and/or data storage 401 to store forward and/or output weight and/or input/output data, and/or other parameters to configure neurons or layers of a neural network trained and/or used for inferencing in aspects of one or more embodiments. In at least one embodiment, training logic 415 may include (or be coupled to code and/or data storage 401 that stores) graph code or other software to control timing and/or order, in which weight and/or other parameter information is to be loaded to configure processing units, including logic units, integer and/or floating point units (collectively, arithmetic logic units (ALUs) or simply circuits). In at least one embodiment, code, such as graph code, loads weight or other parameter information into processor ALUs based on an architecture of a neural network to which such code corresponds. In at least one embodiment, code and/or data storage 401 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 401 may be included with other on-chip or off-chip data storage, including a processor’s L1, L2, or L3 cache or system memory.

In at least one embodiment, any portion of code and/or data storage 401 may be internal or external to one or more processors or other hardware logic devices or circuits. In at least one embodiment, code and/or data storage 401 may be cache memory, dynamic randomly addressable memory (“DRAM”), static randomly addressable memory (“SRAM”), non-volatile memory (e.g., flash memory), or other storage. In at least one embodiment, a choice of whether code and/or data storage 401 is internal or external to a processor, for example, or comprising DRAM, SRAM, flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 415 may include, without limitation, a code and/or data storage 405 to store backward and/or output weight and/or input/output data corresponding to neurons or layers of a neural network trained and/or used for inferencing in aspects of one or more embodiments. In at least one embodiment, code and/or data storage 405 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 415 may include (or be coupled to code and/or data storage 405 that stores) graph code or other software to control timing and/or order, in which weight and/or other parameter information is to be loaded to configure processing units, including logic units, integer and/or floating point units (collectively, arithmetic logic units (ALUs)).

In at least one embodiment, code, such as graph code, causes the loading of weight or other parameter information into processor ALUs based on an architecture of a neural network to which such code corresponds. In at least one embodiment, any portion of code and/or data storage 405 may be included with other on-chip or off-chip data storage, including a processor’s L1, L2, or L3 cache or system memory. In at least one embodiment, any portion of code and/or data storage 405 may be internal or external to one or more processors or other hardware logic devices or circuits. In at least one embodiment, code and/or data storage 405 may be cache memory, DRAM, SRAM, non-volatile memory (e.g., flash memory), or other storage. In at least one embodiment, a choice of whether code and/or data storage 405 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, code and/or code and/or data storage 401 and code and/or data storage 405 may be separate storage structures. In at least one embodiment, code and/or data storage 401 and code and/or data storage 405 may be a combined storage structure. In at least one embodiment, code and/or data storage 401 and code and/or data storage 405 may be partially combined and partially separate. In at least one embodiment, any portion of code and/or data storage 401 and code and/or data storage 405 may be included with other on-chip or off-chip data storage, including a processor’s L1, L2, or L3 cache or system memory.

In at least one embodiment, inference and/or training logic 415 may include, without limitation, one or more arithmetic logic unit(s) (“ALU(s)”) 410, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 420 that are functions of input/output and/or weight parameter data stored in code and/or data storage 401 and/or code and/or data storage 405. In at least one embodiment, activations stored in activation storage 420 are generated according to linear algebraic and or matrix-based mathematics performed by ALU(s) 410 in response to performing instructions or other code, wherein weight values stored in code and/or data storage 405 and/or code and/or data storage 401 are used as operands along with other values, such as bias values, gradient information, momentum values, or other parameters or hyperparameters, any or all of which may be stored in code and/or data storage 405 or code and/or code and/or data storage 401 or another storage on or off-chip.

In at least one embodiment, ALU(s) 410 are included within one or more processors or other hardware logic devices or circuits, whereas in another embodiment, ALU(s) 410 may be external to a processor or other hardware logic device or circuit that uses them (e.g., a co-processor). In at least one embodiment, ALU(s) 410 may be included within a processor’s execution units or otherwise within a bank of ALUs accessible by a processor’s execution units either within the same processor or distributed between different processors of different types (e.g., central processing units, graphics processing units, fixed function units, etc.). In at least one embodiment, code and/or data storage 401, code and/or data storage 405, and activation storage 420 may share a processor or other hardware logic device or circuit, whereas in another embodiment, they may be in different processors or other hardware logic devices or circuits, or some combination of same and different processors or other hardware logic devices or circuits. In at least one embodiment, any portion of activation storage 420 may be included with other on-chip or off-chip data storage, including a processor’s L1, L2, or L3 cache or system memory. Furthermore, inferencing and/or training code may be stored with other code accessible to a processor or other hardware logic or circuit and fetched and/or processed using a processor’s fetch, decode, scheduling, execution, retirement and/or other logical circuits.

In at least one embodiment, activation storage 420 may be cache memory, DRAM, SRAM, non-volatile memory (e.g., flash memory), or other storage. In at least one embodiment, activation storage 420 may be completely or partially within or external to one or more processors or other logical circuits. In at least one embodiment, a choice of whether activation storage 420 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 415 illustrated in FIG. 4A may be used in conjunction with an application-specific integrated circuit (“ASIC”), such as a TensorFlow® Processing Unit from Google, an inference processing unit (IPU) from Graphcore™, or a Nervana® (e.g., “Lake Crest”) processor from Intel Corp. In at least one embodiment, inference and/or training logic 415 illustrated in FIG. 4A may be used in conjunction with central processing unit (“CPU”) hardware, graphics processing unit (“GPU”) hardware or other hardware, such as field programmable gate arrays (“FPGAs”).

FIG. 4B illustrates inference and/or training logic 415, according to at least one embodiment. In at least one embodiment, inference and/or training logic 415 may include, without limitation, hardware logic in which computational resources are dedicated or otherwise exclusively used in conjunction with weight values or other information corresponding to one or more layers of neurons within a neural network. In at least one embodiment, inference and/or training logic 415 illustrated in FIG. 4B may be used in conjunction with an application-specific integrated circuit (ASIC), such as TensorFlow® Processing Unit from Google, an inference processing unit (IPU) from Graphcore™, or a Nervana® (e.g., “Lake Crest”) processor from Intel Corp. In at least one embodiment, inference and/or training logic 415 illustrated in FIG. 4B may be used in conjunction with central processing unit (CPU) hardware, graphics processing unit (GPU) hardware or other hardware, such as field programmable gate arrays (FPGAs). In at least one embodiment, inference and/or training logic 415 includes, without limitation, code and/or data storage 401 and code and/or data storage 405, which may be used to store code (e.g., graph code), weight values and/or other information, including bias values, gradient information, momentum values, and/or other parameter or hyperparameter information. In at least one embodiment illustrated in FIG. 4B, each of code and/or data storage 401 and code and/or data storage 405 is associated with a dedicated computational resource, such as computational hardware 402 and computational hardware 406, respectively. In at least one embodiment, each of computational hardware 402 and computational hardware 406 comprises one or more ALUs that perform mathematical functions, such as linear algebraic functions, only on information stored in code and/or data storage 401 and code and/or data storage 405, respectively, the result of which is stored in activation storage 420.

In at least one embodiment, each of code and/or data storage 401 and 405 and corresponding computational hardware 402 and 406, respectively, correspond to different layers of a neural network, such that resulting activation from one storage/computational pair 401/402 of code and/or data storage 401 and computational hardware 402 is provided as an input to a next storage/computational pair 405/406 of code and/or data storage 405 and computational hardware 406, in order to mirror a conceptual organization of a neural network. In at least one embodiment, each of storage/computational pairs 401/402 and 405/406 may correspond to more than one neural network layer. In at least one embodiment, additional storage/computation pairs (not shown) subsequent to or in parallel with storage/computation pairs 401/402 and 405/406 may be included in inference and/or training logic 415.

### NEURAL NETWORK TRAINING AND DEPLOYMENT

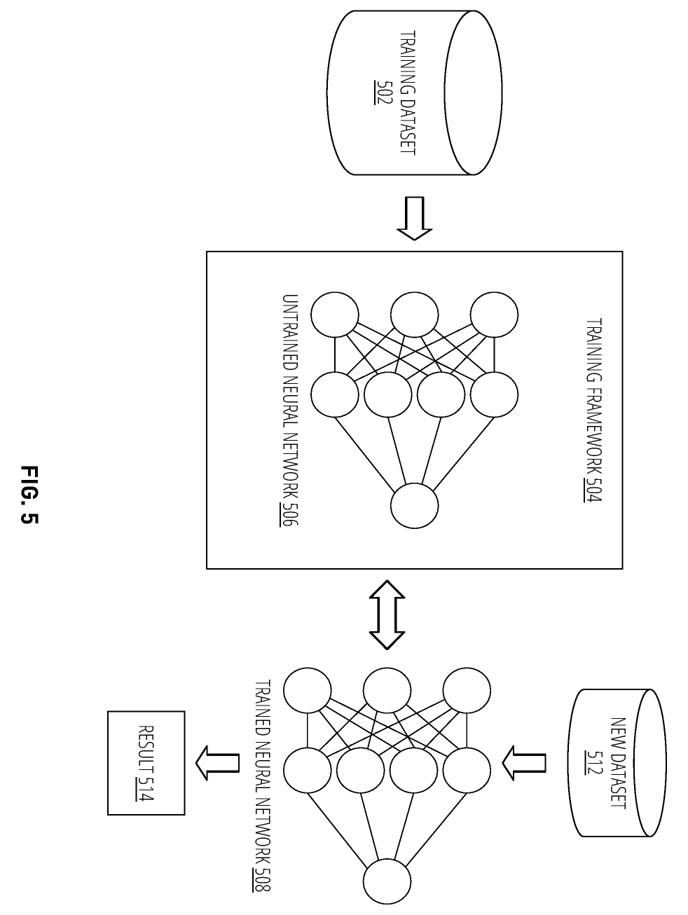

FIG. 5 illustrates training and deployment of a deep neural network, according to at least one embodiment. In at least one embodiment, untrained neural network 506 is trained using a training dataset 502. In at least one embodiment, training framework 504 is a PyTorch framework, whereas in other embodiments, training framework 504 is a TensorFlow, Boost, Caffe, Microsoft Cognitive Toolkit/CNTK, MXNet, Chainer, Keras, Deeplearning4j, or other training framework. In at least one embodiment, training framework 504 trains an untrained neural network 506 and enables it to be trained using processing resources described herein to generate a trained neural network 508. In at least one embodiment, weights may be chosen randomly or by pre-training using a deep belief network. In at least one embodiment, training may be performed in either a supervised, partially supervised, or unsupervised manner.

In at least one embodiment, untrained neural network 506 is trained using supervised learning, wherein training dataset 502 includes an input paired with a desired output for an input, or where training dataset 502 includes input having a known output and an output of neural network 506 is manually graded. In at least one embodiment, untrained neural network 506 is trained in a supervised manner and processes inputs from training dataset 502 and compares resulting outputs against a set of expected or desired outputs. In at least one embodiment, errors are then propagated back through untrained neural network 506. In at least one embodiment, training framework 504 adjusts weights that control untrained neural network 506. In at least one embodiment, training framework 504 includes tools to monitor how well untrained neural network 506 is converging towards a model, such as trained neural network 508, suitable to generating correct answers, such as in result 514, based on input data such as a new dataset 512. In at least one embodiment, training framework 504 trains untrained neural network 506 repeatedly while adjusting weights to refine an output of untrained neural network 506 using a loss function and adjustment algorithm, such as stochastic gradient descent. In at least one embodiment, training framework 504 trains untrained neural network 506 until untrained neural network 506 achieves a desired accuracy. In at least one embodiment, trained neural network 508 can then be deployed to implement any number of machine learning operations.

In at least one embodiment, untrained neural network 506 is trained using unsupervised learning, wherein untrained neural network 506 attempts to train itself using unlabeled data. In at least one embodiment, unsupervised learning training dataset 502 will include input data without any associated output data or “ground truth” data. In at least one embodiment, untrained neural network 506 can learn groupings within training dataset 502 and can determine how individual inputs are related to untrained dataset 502. In at least one embodiment, unsupervised training can be used to generate a self-organizing map in trained neural network 508 capable of performing operations useful in reducing dimensionality of new dataset 512. In at least one embodiment, unsupervised training can also be used to perform anomaly detection, which allows identification of data points in new dataset 512 that deviate from normal patterns of new dataset 512.

In at least one embodiment, semi-supervised learning may be used, which is a technique in which training dataset 502 includes a mix of labeled and unlabeled data. In at least one embodiment, training framework 504 may be used to perform incremental learning, such as through transferred learning techniques. In at least one embodiment, incremental learning enables trained neural network 508 to adapt to new dataset 512 without forgetting knowledge instilled within trained neural network 508 during initial training.

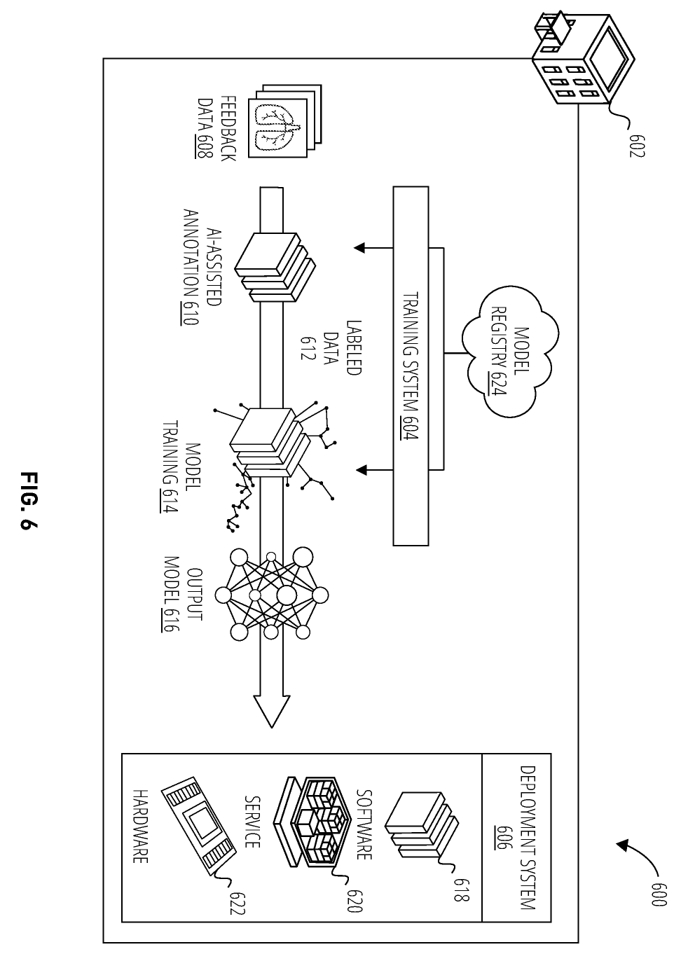

With reference to FIG. 6, FIG. 6 is an example data flow diagram for a process 600 of generating and deploying a processing and inferencing pipeline, according to at least one embodiment. In at least one embodiment, process 600 may be deployed to perform game name recognition analysis and inferencing on user feedback data at one or more facilities 602, such as a data center.

In at least one embodiment, process 600 may be executed within a training system 604 and/or a deployment system 606. In at least one embodiment, training system 604 may be used to perform training, deployment, and embodiment of machine learning models (e.g., neural networks, object detection algorithms, computer vision algorithms, etc.) for use in deployment system 606. In at least one embodiment, deployment system 606 may be configured to offload processing and compute resources among a distributed computing environment to reduce infrastructure requirements at facility 602. In at least one embodiment, deployment system 606 may provide a streamlined platform for selecting, customizing, and implementing virtual instruments for use with computing devices at facility 602. In at least one embodiment, virtual instruments may include software-defined applications for performing one or more processing operations with respect to feedback data. In at least one embodiment, one or more applications in a pipeline may use or call upon services (e.g., inference, visualization, compute, AI, etc.) of deployment system 606 during execution of applications.

In at least one embodiment, some applications used in advanced processing and inferencing pipelines may use machine learning models or other AI to perform one or more processing steps. In at least one embodiment, machine learning models may be trained at facility 602 using feedback data 608 (such as imaging data) stored at facility 602 or feedback data 608 from another facility or facilities, or a combination thereof. In at least one embodiment, training system 604 may be used to provide applications, services, and/or other resources for generating working, deployable machine learning models for deployment system 606.

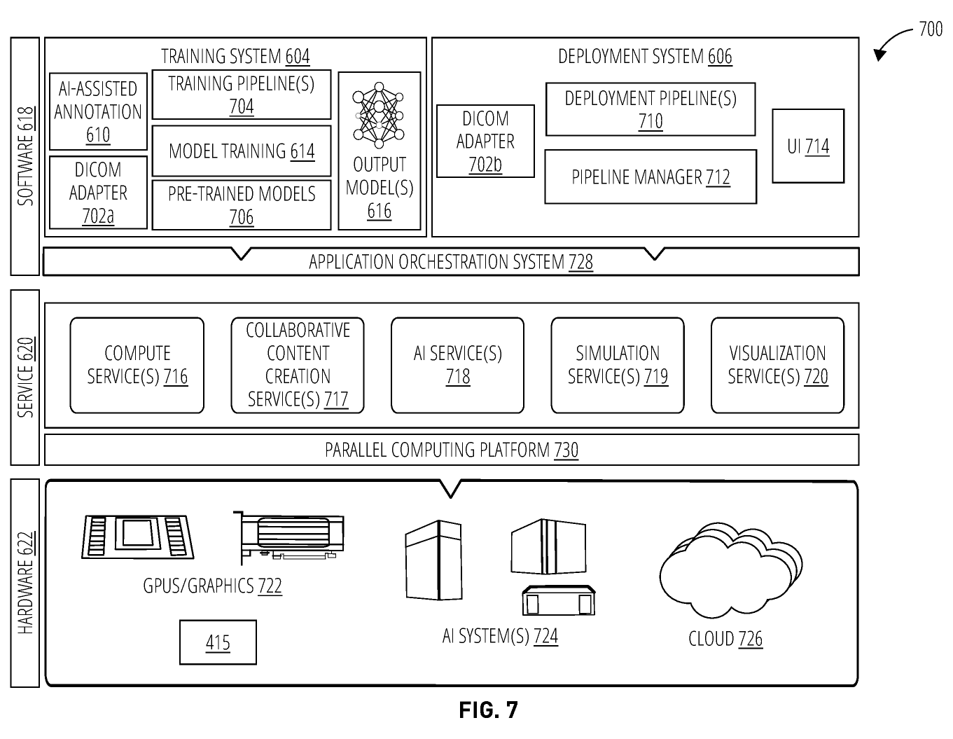

In at least one embodiment, a model registry 624 may be backed by object storage that may support versioning and object metadata. In at least one embodiment, object storage may be accessible through, for example, a cloud storage (e.g., a cloud 726 of FIG. 7) compatible application programming interface (API) from within a cloud platform. In at least one embodiment, machine learning models within model registry 624 may be uploaded, listed, modified, or deleted by developers or partners of a system interacting with an API. In at least one embodiment, an API may provide access to methods that allow users with appropriate credentials to associate models with applications, such that models may be executed as part of execution of containerized instantiations of applications.

In at least one embodiment, a training pipeline(s) 704 (FIG. 7) may include a scenario where facility 602 is training their own machine learning model or has an existing machine learning model that needs to be optimized or updated. In at least one embodiment, feedback data 608 may be received from various channels, such as forums, web forms, or the like. In at least one embodiment, once feedback data 608 is received, AI-assisted annotation 610 may be used to aid in generating annotations corresponding to feedback data 608 to be used as ground truth data for a machine learning model. In at least one embodiment, AI-assisted annotation 610 may include one or more machine learning models (e.g., convolutional neural networks (CNNs)) that may be trained to generate annotations corresponding to certain types of feedback data 608 (e.g., from certain devices) and/or certain types of anomalies in feedback data 608. In at least one embodiment, AI-assisted annotations 610 may then be used directly, or may be adjusted or fine-tuned using an annotation tool, to generate ground truth data. In at least one embodiment, in some examples, labeled data 612 may be used as ground truth data for training a machine learning model. In at least one embodiment, AI-assisted annotations 610, labeled data 612, or a combination thereof may be used as ground truth data for training a machine learning model, e.g., via model training 614 in FIG. 6 and/or FIG. 7. In at least one embodiment, a trained machine learning model may be referred to as an output model 616, and may be used by deployment system 606, as described herein.

In at least one embodiment, training pipeline(s) 704 (FIG. 7) may include a scenario where facility 602 needs a machine learning model for use in performing one or more processing tasks for one or more applications in deployment system 606, but facility 602 may not currently have such a machine learning model (or may not have a model that is optimized, efficient, or effective for such purposes). In at least one embodiment, an existing machine learning model may be selected from model registry 624. In at least one embodiment, model registry 624 may include machine learning models trained to perform a variety of different inference tasks on imaging data. In at least one embodiment, machine learning models in model registry 624 may have been trained on imaging data from different facilities than facility 602 (e.g., facilities that are remotely located). In at least one embodiment, machine learning models may have been trained on imaging data from one location, two locations, or any number of locations. In at least one embodiment, when being trained on imaging data, which may be a form of feedback data 608, from a specific location, training may take place at that location, or at least in a manner that protects confidentiality of imaging data or restricts imaging data from being transferred off-premises (e.g., to comply with HIPAA regulations, privacy regulations, etc.). In at least one embodiment, once a model is trained – or partially trained – at one location, a machine learning model may be added to model registry 624. In at least one embodiment, a machine learning model may then be retrained, or updated, at any number of other facilities, and a retrained or updated model may be made available in model registry 624. In at least one embodiment, a machine learning model may then be selected from model registry 624 – and referred to as output model(s) 616– and may be used in deployment system 606 to perform one or more processing tasks for one or more applications of a deployment system.

In at least one embodiment, training pipeline(s) 704 (FIG. 7) may be used in a scenario that includes facility 602 requiring a machine learning model for use in performing one or more processing tasks for one or more applications in deployment system 606, but facility 602 may not currently have such a machine learning model (or may not have a model that is optimized, efficient, or effective for such purposes). In at least one embodiment, a machine learning model selected from model registry 624 might not be fine-tuned or optimized for feedback data 608 generated at facility 602 because of differences in populations, genetic variations, robustness of training data used to train a machine learning model, diversity in anomalies of training data, and/or other issues with training data. In at least one embodiment, AI-assisted annotation 610 may be used to aid in generating annotations corresponding to feedback data 608 to be used as ground truth data for retraining or updating a machine learning model. In at least one embodiment, labeled data 612 may be used as ground truth data for training a machine learning model. In at least one embodiment, retraining or updating a machine learning model may be referred to as model training 614. In at least one embodiment, model training 614 may include data – e.g., AI-assisted annotations 610, labeled data 612, or a combination thereof – that may be used as ground truth data for retraining or updating a machine learning model.

In at least one embodiment, deployment system 606 may include software 618, service 620, hardware 622, and/or other components, features, and functionality. In at least one embodiment, deployment system 606 may include a software “stack,” such that software 618 may be built on top of service 620 and may use service 620 to perform some or all of processing tasks, and service 620 and software 618 may be built on top of hardware 622 and use hardware 622 to execute processing, storage, and/or other compute tasks of deployment system 606.

In at least one embodiment, software 618 may include any number of different containers, where each container may execute an instantiation of an application. In at least one embodiment, each application may perform one or more processing tasks in an advanced processing and inferencing pipeline (e.g., inferencing, object detection, feature detection, segmentation, image enhancement, calibration, etc.). In at least one embodiment, for each type of computing device there may be any number of containers that may perform a data processing task with respect to feedback data 608 (or other data types, such as those described herein). In at least one embodiment, an advanced processing and inferencing pipeline may be defined based on selections of different containers that are desired or required for processing feedback data 608, in addition to containers that receive and configure imaging data for use by each container and/or for use by facility 602 after processing through a pipeline (e.g., to convert outputs back to a usable data type for storage and display at facility 602). In at least one embodiment, a combination of containers within software 618 (e.g., that make up a pipeline) may be referred to as a virtual instrument (as described in more detail herein), and a virtual instrument may leverage service 620 and hardware 622 to execute some or all processing tasks of applications instantiated in containers.

In at least one embodiment, data may undergo pre-processing as part of data processing pipeline to prepare data for processing by one or more applications. In at least one embodiment, post-processing may be performed on an output of one or more inferencing tasks or other processing tasks of a pipeline to prepare an output data for a next application and/or to prepare output data for transmission and/or use by a user (e.g., as a response to an inference request). In at least one embodiment, inferencing tasks may be performed by one or more machine learning models, such as trained or deployed neural networks, which may include output model(s) 616 of training system 604.

In at least one embodiment, tasks of data processing pipeline may be encapsulated in one or more container(s) that each represent a discrete, fully functional instantiation of an application and virtualized computing environment that is able to reference machine learning models. In at least one embodiment, containers or applications may be published into a private (e.g., limited access) area of a container registry (described in more detail herein), and trained or deployed models may be stored in model registry 624 and associated with one or more applications. In at least one embodiment, images of applications (e.g., container images) may be available in a container registry, and once selected by a user from a container registry for deployment in a pipeline, an image may be used to generate a container for an instantiation of an application for use by a user system.

In at least one embodiment, developers may develop, publish, and store applications (e.g., as containers) for performing processing and/or inferencing on supplied data. In at least one embodiment, development, publishing, and/or storing may be performed using a software development kit (SDK) associated with a system (e.g., to ensure that an application and/or container developed is compliant with or compatible with a system). In at least one embodiment, an application that is developed may be tested locally (e.g., at a first facility, on data from a first facility) with an SDK which may support at least some of services 620 as a system (e.g., system 700 of FIG. 7). In at least one embodiment, once validated by system 700 (e.g., for accuracy, etc.), an application may be available in a container registry for selection and/or embodiment by a user (e.g., a hospital, clinic, lab, healthcare provider, etc.) to perform one or more processing tasks with respect to data at a facility (e.g., a second facility) of a user.

In at least one embodiment, developers may then share applications or containers through a network for access and use by users of a system (e.g., system 700 of FIG. 7). In at least one embodiment, completed and validated applications or containers may be stored in a container registry and associated machine learning models may be stored in model registry 624. In at least one embodiment, a requesting entity that provides an inference or image processing request may browse a container registry and/or model registry 624 for an application, container, dataset, machine learning model, etc., select a desired combination of elements for inclusion in data processing pipeline, and submit a processing request. In at least one embodiment, a request may include input data that is necessary to perform a request, and/or may include a selection of application(s) and/or machine learning models to be executed in processing a request. In at least one embodiment, a request may then be passed to one or more components of deployment system 606 (e.g., a cloud) to perform processing of a data processing pipeline. In at least one embodiment, processing by deployment system 606 may include referencing selected elements (e.g., applications, containers, models, etc.) from a container registry and/or model registry 624. In at least one embodiment, once results are generated by a pipeline, results may be returned to a user for reference (e.g., for viewing in a viewing application suite executing on a local, on-premises workstation or terminal).

In at least one embodiment, to aid in processing or execution of applications or containers in pipelines, service 620 may be leveraged. In at least one embodiment, service 620 may include compute services, collaborative content creation services, simulation services, artificial intelligence (AI) services, visualization services, and/or other service types. In at least one embodiment, service 620 may provide functionality that is common to one or more applications in software 618, so functionality may be abstracted to a service that may be called upon or leveraged by applications. In at least one embodiment, functionality provided by service 620 may run dynamically and more efficiently, while also scaling well by allowing applications to process data in parallel, e.g., using a parallel computing platform 730 (FIG. 7). In at least one embodiment, rather than each application that shares a same functionality offered by a service 620 being required to have a respective instance of service 620, service 620 may be shared between and among various applications. In at least one embodiment, services may include an inference server or engine that may be used for executing detection or segmentation tasks, as non-limiting examples. In at least one embodiment, a model training service may be included that may provide machine learning model training and/or retraining capabilities.

In at least one embodiment, where a service 620 includes an AI service (e.g., an inference service), one or more machine learning models associated with an application for anomaly detection (e.g., tumors, growth abnormalities, scarring, etc.) may be executed by calling upon (e.g., as an API call) an inference service (e.g., an inference server) to execute machine learning model(s), or processing thereof, as part of application execution. In at least one embodiment, where another application includes one or more machine learning models for segmentation tasks, an application may call upon an inference service to execute machine learning models for performing one or more processing operations associated with segmentation tasks. In at least one embodiment, software 618 implementing advanced processing and inferencing pipeline may be streamlined because each application may call upon the same inference service to perform one or more inferencing tasks.

In at least one embodiment, hardware 622 may include GPUs, CPUs, graphics cards, an AI/deep learning system (e.g., an AI supercomputer, such as NVIDIA’s DGX^{TM} supercomputer system), a cloud platform, or a combination thereof. In at least one embodiment, different types of hardware 622 may be used to provide efficient, purpose-built support for software 618 and service 620 in deployment system 606. In at least one embodiment, use of GPU processing may be implemented for processing locally (e.g., at facility 602), within an AI/deep learning system, in a cloud system, and/or in other processing components of deployment system 606 to improve efficiency, accuracy, and efficacy of game name recognition.

In at least one embodiment, software 618 and/or service 620 may be optimized for GPU processing with respect to deep learning, machine learning, and/or high-performance computing, simulation, and visual computing, as non-limiting examples. In at least one embodiment, at least some of the computing environment of deployment system 606 and/or training system 604 may be executed in a datacenter or one or more supercomputers or high performance computing systems, with GPU-optimized software (e.g., hardware and software combination of NVIDIA’s DGX^{TM} system). In at least one embodiment, hardware 622 may include any number of GPUs that may be called upon to perform processing of data in parallel, as described herein. In at least one embodiment, cloud platform may further include GPU processing for GPU-optimized execution of deep learning tasks, machine learning tasks, or other computing tasks. In at least one embodiment, cloud platform (e.g., NVIDIA’s NGC^{TM}) may be executed using an AI/deep learning supercomputer(s) and/or GPU-optimized software (e.g., as provided on NVIDIA’s DGX^{TM} systems) as a hardware abstraction and scaling platform. In at least one embodiment, cloud platform may integrate an application container clustering system or orchestration system (e.g., KUBERNETES) on multiple GPUs to enable seamless scaling and load balancing.

FIG. 7 is a system diagram for an example system 700 for generating and deploying a deployment pipeline, according to at least one embodiment. In at least one embodiment, system 700 may be used to implement process 600 of FIG. 6 and/or other processes including advanced processing and inferencing pipelines. In at least one embodiment, system 700 may include training system 604 and deployment system 606. In at least one embodiment, training system 604 and deployment system 606 may be implemented using software 618, services 620, and/or hardware 622, as described herein.

In at least one embodiment, system 700 (e.g., training system 604 and/or deployment system 606) may implemented in a cloud computing environment (e.g., using cloud 726). In at least one embodiment, system 700 may be implemented locally with respect to a facility, or as a combination of both cloud and local computing resources. In at least one embodiment, access to APIs in cloud 726 may be restricted to authorized users through enacted security measures or protocols. In at least one embodiment, a security protocol may include web tokens that may be signed by an authentication (e.g., AuthN, AuthZ, Gluecon, etc.) service and may carry appropriate authorization. In at least one embodiment, APIs of virtual instruments (described herein), or other instantiations of system 700, may be restricted to a set of public internet service providers (ISPs) that have been vetted or authorized for interaction.

In at least one embodiment, various components of system 700 may communicate between and among one another using any of a variety of different network types, including but not limited to local area networks (LANs) and/or wide area networks (WANs) via wired and/or wireless communication protocols. In at least one embodiment, communication between facilities and components of system 700 (e.g., for transmitting inference requests, for receiving results of inference requests, etc.) may be communicated over a data bus or data busses, wireless data protocols (e.g., Wi-Fi), wired data protocols (e.g., Ethernet), etc.

In at least one embodiment, training system 604 may execute training pipelines 704, similar to those described herein with respect to FIG. 6. In at least one embodiment, where one or more machine learning models are to be used in deployment pipeline(s) 710 by deployment system 606, training pipeline(s) 704 may be used to train or retrain one or more (e.g., pre-trained) models, and/or implement one or more of pre-trained models 706 (e.g., without a need for retraining or updating). In at least one embodiment, as a result of training pipeline(s) 704, output model(s) 616 may be generated. In at least one embodiment, training pipeline(s) 704 may include any number of processing steps, AI-assisted annotation 610, labeling or annotating of feedback data 608 to generate labeled data 612, model selection from a model registry, model training 614, training, retraining, or updating models, and/or other processing steps. In at least one embodiment, DICOM adapter 702a can be used to access DICOM data. In at least one embodiment, for different machine learning models used by deployment system 606, different training pipeline(s) 704 may be used. In at least one embodiment, training pipeline(s) 704, similar to a first example described with respect to FIG. 6, may be used for a first machine learning model, training pipeline(s) 704, similar to a second example described with respect to FIG. 6, may be used for a second machine learning model, and training pipeline(s) 704, similar to a third example described with respect to FIG. 6, may be used for a third machine learning model. In at least one embodiment, any combination of tasks within training system 604 may be used depending on what is required for each respective machine learning model. In at least one embodiment, one or more of machine learning models may already be trained and ready for deployment so machine learning models may not undergo any processing by training system 604 and may be implemented by deployment system 606.

In at least one embodiment, output model(s) 616 and/or pre-trained models 706 may include any types of machine learning models depending on embodiment. In at least one embodiment, and without limitation, machine learning models used by system 700 may include machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Bi-LSTM, Hopfield, Boltzmann, deep belief, deconvolutional, generative adversarial, liquid state machine, etc.), and/or other types of machine learning models.

In at least one embodiment, training pipeline(s) 704 may include AI-assisted annotation. In at least one embodiment, labeled data 612 (e.g., traditional annotation) may be generated by any number of techniques. In at least one embodiment, labels or other annotations may be generated within a drawing program (e.g., an annotation program), a computer aided design (CAD) program, a labeling program, another type of program suitable for generating annotations or labels for ground truth, and/or may be hand drawn, in some examples. In at least one embodiment, ground truth data may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines location of labels), and/or a combination thereof. In at least one embodiment, for each instance of feedback data 608 (or other data type used by machine learning models), there may be corresponding ground truth data generated by training system 604. In at least one embodiment, AI-assisted annotation may be performed as part of deployment pipeline(s) 710; either in addition to, or in lieu of, AI-assisted annotation included in training pipeline(s) 704. In at least one embodiment, system 700 may include a multi-layer platform that may include a software layer (e.g., software 618) of diagnostic applications (or other application types) that may perform one or more medical imaging and diagnostic functions.

In at least one embodiment, a software layer may be implemented as a secure, encrypted, and/or authenticated API through which applications or containers may be invoked (e.g., called) from an external environment(s), e.g., facility 602. In at least one embodiment, applications may then call or execute one or more services 620 for performing compute, AI, or visualization tasks associated with respective applications, and software 618 and/or services 620 may leverage hardware 622 to perform processing tasks in an effective and efficient manner.

In at least one embodiment, deployment system 606 may execute deployment pipelines 710. In at least one embodiment, deployment pipeline(s) 710 may include any number of applications that may be sequentially, non-sequentially, or otherwise applied to feedback data (and/or other data types), including AI-assisted annotation, as described above. In at least one embodiment, as described herein, a deployment pipeline(s) 710 for an individual device may be referred to as a virtual instrument for a device. In at least one embodiment, for a single device, there may be more than one deployment pipeline(s) 710 depending on information desired from data generated by a device.

In at least one embodiment, applications available for deployment pipeline(s) 710 may include any application that may be used for performing processing tasks on feedback data or other data from devices. In at least one embodiment, because various applications may share common image operations, in some embodiments, a data augmentation library (e.g., as one of services 620) may be used to accelerate these operations. In at least one embodiment, to avoid bottlenecks of conventional processing approaches that rely on CPU processing, parallel computing platform 730 may be used for GPU acceleration of these processing tasks.

In at least one embodiment, deployment system 606 may include a user interface (UI) 714 (e.g., a graphical user interface, a web interface, etc.) that may be used to select applications for inclusion in deployment pipeline(s) 710, arrange applications, modify or change applications or parameters or constructs thereof, use and interact with deployment pipeline(s) 710 during set-up and/or deployment, and/or to otherwise interact with deployment system 606. In at least one embodiment, although not illustrated with respect to training system 604, UI 714 (or a different user interface) may be used for selecting models for use in deployment system 606, for selecting models for training, or retraining, in training system 604, and/or for otherwise interacting with training system 604.

In at least one embodiment, pipeline manager 712 may be used, in addition to an application orchestration system 728, to manage interaction between applications or containers of deployment pipeline(s) 710 and services 620 and/or hardware 622. In at least one embodiment, pipeline manager 712 may be configured to facilitate interactions from application to application, from application to service 620, and/or from application or service to hardware 622. In at least one embodiment, although illustrated as included in software 618, this is not intended to be limiting, and in some examples pipeline manager 712 may be included in services 620. In at least one embodiment, application orchestration system 728 (e.g., Kubernetes, DOCKER, etc.) may include a container orchestration system that may group applications into containers as logical units for coordination, management, scaling, and deployment. In at least one embodiment, by associating applications from deployment pipeline(s) 710 (e.g., a reconstruction application, a segmentation application, etc.) with individual containers, each application may execute in a self-contained environment (e.g., at a kernel level) to increase speed and efficiency.

In at least one embodiment, each application and/or container (or image thereof) may be individually developed, modified, and deployed (e.g., a first user or developer may develop, modify, and deploy a first application and a second user or developer may develop, modify, and deploy a second application separate from a first user or developer), which may allow for focus on, and attention to, a task of a single application and/or container(s) without being hindered by tasks of other application(s) or container(s). In at least one embodiment, communication, and cooperation between different containers or applications may be aided by pipeline manager 712 and application orchestration system 728. In at least one embodiment, so long as an expected input and/or output of each container or application is known by a system (e.g., based on constructs of applications or containers), application orchestration system 728 and/or pipeline manager 712 may facilitate communication among and between, and sharing of resources among and between, each of the applications or containers. In at least one embodiment, because one or more of applications or containers in deployment pipeline(s) 710 may share the same services and resources, application orchestration system 728 may orchestrate, load balance, and determine sharing of services or resources between and among various applications or containers. In at least one embodiment, a scheduler may be used to track resource requirements of applications or containers, current usage or planned usage of these resources, and resource availability. In at least one embodiment, the scheduler may thus allocate resources to different applications and distribute resources between and among applications in view of requirements and availability of a system. In some examples, the scheduler (and/or other component of application orchestration system 728) may determine resource availability and distribution based on constraints imposed on a system (e.g., user constraints), such as quality of service (QoS), urgency of need for data outputs (e.g., to determine whether to execute real-time processing or delayed processing), etc.

In at least one embodiment, services 620 leveraged and shared by applications or containers in deployment system 606 may include compute service(s) 716, collaborative content creation service(s) 717, AI service(s) 718, simulation service(s) 719, visualization service(s) 720, and/or other service types. In at least one embodiment, applications may call (e.g., execute) one or more of services 620 to perform processing operations for an application. In at least one embodiment, compute service(s) 716 may be leveraged by applications to perform super-computing or other high-performance computing (HPC) tasks. In at least one embodiment, compute service(s) 716 may be leveraged to perform parallel processing (e.g., using a parallel computing platform 730) for processing data through one or more of applications and/or one or more tasks of a single application, substantially simultaneously. In at least one embodiment, parallel computing platform 730 (e.g., NVIDIA’s CUDA^{®}) may enable general purpose computing on GPUs (GPGPU) (e.g., GPUs/graphics 722). In at least one embodiment, a software layer of parallel computing platform 730 may provide access to virtual instruction sets and parallel computational elements of GPUs, for execution of compute kernels. In at least one embodiment, parallel computing platform 730 may include memory and, in some embodiments, a memory may be shared between and among multiple containers and/or between and among different processing tasks within a single container. In at least one embodiment, inter-process communication (IPC) calls may be generated for multiple containers and/or for multiple processes within a container to use same data from a shared segment of memory of parallel computing platform 730 (e.g., where multiple different stages of an application or multiple applications are processing same information). In at least one embodiment, rather than making a copy of data and moving data to different locations in memory (e.g., a read/write operation), same data in the same location of a memory may be used for any number of processing tasks (e.g., at the same time, at different times, etc.). In at least one embodiment, as data is used to generate new data as a result of processing, this information of a new location of data may be stored and shared between various applications. In at least one embodiment, location of data and a location of updated or modified data may be part of a definition of how a payload is understood within containers.

In at least one embodiment, AI service(s) 718 may be leveraged to perform inferencing services for executing machine learning model(s) associated with applications (e.g., tasked with performing one or more processing tasks of an application). In at least one embodiment, AI service(s) 718 may leverage AI system(s) 724 to execute machine learning model(s) (e.g., neural networks, such as CNNs) for segmentation, reconstruction, object detection, feature detection, classification, and/or other inferencing tasks. In at least one embodiment, applications of deployment pipeline(s) 710 may use one or more of output model(s) 616 from training system 604 and/or other models of applications to perform inference on imaging data (e.g., DICOM data, RIS data, CIS data, REST compliant data, RPC data, raw data, etc.). For example, DICOM adapter 702b may be used to access DICOM data. In at least one embodiment, two or more examples of inferencing using application orchestration system 728 (e.g., a scheduler) may be available. In at least one embodiment, a first category may include a high priority/low latency path that may achieve higher service level agreements, such as for performing inference on urgent requests during an emergency, or for a radiologist during diagnosis. In at least one embodiment, a second category may include a standard priority path that may be used for requests that may be non-urgent or where analysis may be performed at a later time. In at least one embodiment, application orchestration system 728 may distribute resources (e.g., services 620 and/or hardware 622) based on priority paths for different inferencing tasks of AI service(s) 718.

In at least one embodiment, shared storage may be mounted to AI service(s) 718 within system 700. In at least one embodiment, shared storage may operate as a cache (or other storage device type) and may be used to process inference requests from applications. In at least one embodiment, when an inference request is submitted, a request may be received by a set of API instances of deployment system 606, and one or more instances may be selected (e.g., for best fit, for load balancing, etc.) to process a request. In at least one embodiment, to process a request, a request may be entered into a database, a machine learning model may be located from model registry 624 if not already in a cache, a validation step may ensure an appropriate machine learning model is loaded into a cache (e.g., shared storage), and/or a copy of a model may be saved to a cache. In at least one embodiment, the scheduler (e.g., of pipeline manager 712) may be used to launch an application that is referenced in a request if an application is not already running or if there are not enough instances of an application. In at least one embodiment, if an inference server is not already launched to execute a model, an inference server may be launched. In at least one embodiment, any number of inference servers may be launched per model. In at least one embodiment, in a pull model, in which inference servers are clustered, models may be cached whenever load balancing is advantageous. In at least one embodiment, inference servers may be statically loaded in corresponding, distributed servers.

In at least one embodiment, inferencing may be performed using an inference server that runs in a container. In at least one embodiment, an instance of an inference server may be associated with a model (and optionally a plurality of versions of a model). In at least one embodiment, if an instance of an inference server does not exist when a request to perform inference on a model is received, a new instance may be loaded. In at least one embodiment, when starting an inference server, a model may be passed to an inference server such that a same container may be used to serve different models so long as the inference server is running as a different instance.

In at least one embodiment, during application execution, an inference request for a given application may be received, and a container (e.g., hosting an instance of an inference server) may be loaded (if not already loaded), and a start procedure may be called. In at least one embodiment, pre-processing logic in a container may load, decode, and/or perform any additional pre-processing on incoming data (e.g., using a CPU(s) and/or GPU(s)). In at least one embodiment, once data is prepared for inference, a container may perform inference as necessary on data. In at least one embodiment, this may include a single inference call on one image (e.g., a hand X-ray), or may require inference on hundreds of images (e.g., a chest CT). In at least one embodiment, an application may summarize results before completing, which may include, without limitation, a single confidence score, pixel-level segmentation, voxel-level segmentation, generating a visualization, or generating text to summarize findings. In at least one embodiment, different models or applications may be assigned different priorities. For example, some models may have a real-time (turnaround time less than one minute) priority while others may have lower priority (e.g., turnaround less than 10 minutes). In at least one embodiment, model execution times may be measured from requesting institution or entity and may include partner network traversal time, as well as execution on an inference service.

In at least one embodiment, transfer of requests between services 620 and inference applications may be hidden behind a software development kit (SDK), and robust transport may be provided through a queue. In at least one embodiment, a request is placed in a queue via an API for an individual application/tenant ID combination and an SDK pulls a request from a queue and gives a request to an application. In at least one embodiment, a name of a queue may be provided in an environment from where an SDK picks up the request. In at least one embodiment, asynchronous communication through a queue may be useful as it may allow any instance of an application to pick up work as it becomes available. In at least one embodiment, results may be transferred back through a queue, to ensure no data is lost. In at least one embodiment, queues may also provide an ability to segment work, as highest priority work may go to a queue with most instances of an application connected to it, while lowest priority work may go to a queue with a single instance connected to it that processes tasks in an order received. In at least one embodiment, an application may run on a GPU-accelerated instance generated in cloud 726, and an inference service may perform inferencing on a GPU.

In at least one embodiment, visualization service(s) 720 may be leveraged to generate visualizations for viewing outputs of applications and/or deployment pipeline(s) 710. In at least one embodiment, GPUs/graphics 722 may be leveraged by visualization service(s) 720 to generate visualizations. In at least one embodiment, rendering effects, such as ray-tracing or other light transport simulation techniques, may be implemented by visualization service(s) 720 to generate higher quality visualizations. In at least one embodiment, visualizations may include, without limitation, 2D image renderings, 3D volume renderings, 3D volume reconstruction, 2D tomographic slices, virtual reality displays, augmented reality displays, etc. In at least one embodiment, virtualized environments may be used to generate a virtual interactive display or environment (e.g., a virtual environment) for interaction by users of a system (e.g., doctors, nurses, radiologists, etc.). In at least one embodiment, visualization service(s) 720 may include an internal visualizer, cinematics, and/or other rendering or image processing capabilities or functionality (e.g., ray tracing, rasterization, internal optics, etc.).

In at least one embodiment, hardware 622 may include GPUs/graphics 722, AI system(s) 724, cloud 726, and/or any other hardware used for executing training system 604 and/or deployment system 606. In at least one embodiment, GPUs/graphics 722 (e.g., NVIDIA’s TESLA^{®} and/or QUADRO^{®} GPUs) may include any number of GPUs that may be used for executing processing tasks of compute service(s) 716, collaborative content creation service(s) 717, AI service(s) 718, simulation service(s) 719, visualization service(s) 720, other services, and/or any of features or functionality of software 618. For example, with respect to AI service(s) 718, GPUs/graphics 722 may be used to perform pre-processing on imaging data (or other data types used by machine learning models), post-processing on outputs of machine learning models, and/or to perform inferencing (e.g., to execute machine learning models). In at least one embodiment, cloud 726, AI system(s) 724, and/or other components of system 700 may use GPUs/graphics 722. In at least one embodiment, cloud 726 may include a GPU-optimized platform for deep learning tasks. In at least one embodiment, AI system(s) 724 may use GPUs, and cloud 726 – or at least a portion tasked with deep learning or inferencing – may be executed using one or more AI system(s)s 724. As such, although hardware 622 is illustrated as discrete components, this is not intended to be limiting, and any components of hardware 622 may be combined with, or leveraged by, any other components of hardware 622.

In at least one embodiment, AI system(s) 724 may include a purpose-built computing system (e.g., a super-computer or an HPC) configured for inferencing, deep learning, machine learning, and/or other artificial intelligence tasks. In at least one embodiment, AI system(s) 724 (e.g., NVIDIA’s DGX^{TM}) may include GPU-optimized software (e.g., a software stack) that may be executed using a plurality of GPUs/graphics 722, in addition to CPUs, RAM, storage, and/or other components, features, or functionality. In at least one embodiment, one or more AI system(s)s 724 may be implemented in cloud 726 (e.g., in a data center) for performing some or all of AI-based processing tasks of system 700.

In at least one embodiment, cloud 726 may include a GPU-accelerated infrastructure (e.g., NVIDIA’s NGC^{TM}) that may provide a GPU-optimized platform for executing processing tasks of system 700. In at least one embodiment, cloud 726 may include an AI system(s) 724 for performing one or more of AI-based tasks of system 700 (e.g., as a hardware abstraction and scaling platform). In at least one embodiment, cloud 726 may integrate with application orchestration system 728 leveraging multiple GPUs to enable seamless scaling and load balancing between and among applications and services 620. In at least one embodiment, cloud 726 may be tasked with executing at least some of services 620 of system 700, including compute service(s) 716, AI service(s) 718, and/or visualization service(s) 720, as described herein. In at least one embodiment, cloud 726 may perform small and large batch inference (e.g., executing NVIDIA’s TensorRT^{TM}), provide an accelerated parallel computing platform 730 (e.g., NVIDIA’s CUDA^{®}), execute application orchestration system 728 (e.g., KUBERNETES), provide a graphics rendering API and platform (e.g., for ray-tracing, 2D graphics, 3D graphics, and/or other rendering techniques to produce higher quality cinematics), and/or may provide other functionality for system 700. In at least one embodiment, parallel computing platform 730 may include an API.

In at least one embodiment, in an effort to preserve patient confidentiality (e.g., where patient data or records are to be used off-premises), cloud 726 may include a registry, such as a deep learning container registry. In at least one embodiment, a registry may store containers for instantiations of applications that may perform pre-processing, post-processing, or other processing tasks on patient data. In at least one embodiment, cloud 726 may receive data that includes patient data as well as sensor data in containers, perform requested processing for just sensor data in those containers, and then forward a resultant output and/or visualizations to appropriate parties and/or devices (e.g., on-premises medical devices used for visualization or diagnoses), all without having to extract, store, or otherwise access patient data. In at least one embodiment, confidentiality of patient data is preserved in compliance with HIPAA and/or other data regulations.

Other variations are within the spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). In at least one embodiment, a number of items in a plurality is at least two but can be more when so indicated either explicitly or by context. Further, unless stated otherwise or otherwise clear from context, the phrase “based on” means “based at least in part on” or “based at least on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in the form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors — for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to the same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, in some embodiments, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system’s registers and/or memories into other data similarly represented as physical quantities within computing system’s memories, registers or other such information storage, transmission or display devices.

In a similar manner, the term “processor” may refer to any device or portion of a device that processes electronic data from registers and/or memory and transforms that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as a system may embody one or more methods and methods may be considered a system.

In the present document, references may be made to obtaining, acquiring, receiving, or inputting analog or digital data into a subsystem, computer system, or computer-implemented machine. In at least one embodiment, a process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example embodiments of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method comprising:
receiving, from a device of a user, an indication of one or more applications executable in a computing environment, at least one application of the one or more applications having associated dependency information;
generating, based on the one or more applications and associated dependency information, a set of dependency constraints;
determining a solution to the set of dependency constraints;
determining a collection of applications based on the solution to the set of dependency constraints; and
generating, based on the collection of applications, a representation of operations to be performed to prepare the one or more applications for execution in the computing environment.

2. The method of claim 1, wherein the set of dependency constraints is a Boolean satisfiability formula.

3. The method of claim 1, wherein determining the solution to the set of dependency constraints comprises at least one of:
determining if the set of dependency constraints is satisfiable; or
applying a machine learning model to the set of dependency constraints.

4. The method of claim 1, further comprising sorting the collection of applications to determine an order of operations, wherein the generating the representation of operations is further based on the order of operations.

5. The method of claim 4, wherein the sorting the collection of applications comprises determining, for the at least one application, a target environment, wherein the target environment is at least one of a build environment or a runtime environment.

6. The method of claim 1, wherein the computing environment is a containerized computing environment.

7. The method of claim 1, further comprising:
generating a container configuration file based on the representation of operations; and
providing the container configuration file to the user.

8. The method of claim 1, wherein a first application of the one or more applications comprises at least one of:
a Debian package;
a Python package; or
a built-from-source package.

9. A system comprising:
one or more processing devices to perform operations comprising:
receiving, from a device of a user, an indication of one or more applications executable in a computing environment, at least one application of the one or more applications having associated dependency information;
generating, based on the one or more applications and associated dependency information, a set of dependency constraints;
determining a solution to the set of dependency constraints;
determining a collection of applications based on the solution to the set of dependency constraints; and
generating, based on the collection of applications, a representation of operations to be performed to prepare the one or more applications for execution in the computing environment.

10. The system of claim 9, wherein the set of dependency constraints is a Boolean satisfiability formula.

11. The system of claim 9, wherein determining the solution to the set of dependency constraints comprises at least one of:
determining if the set of dependency constraints is satisfiable; or
applying a machine learning model to the set of dependency constraints.

12. The system of claim 9, the operations further comprising sorting the collection of applications to determine an order of operations, wherein the generating the representation of operations is further based on the order of operations.

13. The system of claim 12, wherein the sorting the collection of applications comprises determining, for the at least one application, a target environment, wherein the target environment is at least one of a build environment or a runtime environment.

14. The system of claim 9, wherein the computing environment is a containerized computing environment.

15. The system of claim 9, the operations further comprising:
generating a container configuration file based on the representation of operations; and
providing the container configuration file to the user.

16. The system of claim 9, wherein a first application of the one or more applications comprises at least one of:
a Debian package;
a Python package; or
a built-from-source package.

17. A processor comprising one or more processing units to:
receive, from a device of a user, an indication of one or more applications executable in a computing environment, at least one application of the one or more applications having associated dependency information;
generate, based on the one or more applications and associated dependency information, a set of dependency constraints;
determine a solution to the set of dependency constraints;
determine a collection of applications based on the solution to the set of dependency constraints; and
generate, based on the collection of applications, a representation of operations to be performed to prepare the one or more applications for execution in the computing environment.

18. The processor of claim 17, wherein the set of dependency constraints is a Boolean satisfiability formula.

19. The processor of claim 17, wherein to determine the solution to the set of dependency constraints, the one or more processing units are to at least one of:
determine if the set of dependency constraints is satisfiable; or
apply a machine learning model to the set of dependency constraints.

20. The processor of claim 17, the one or more processing units further to sort the collection of applications to determine an order of operations, wherein generating the representation of operations is further based on the order of operations.
